(19) United States
(12) Patent Application Publication
(10) Pub. No.: US 2026/0049027 A1
(43) Pub. Date: Feb. 19, 2026

(54) CALCINATION SYSTEM AND METHOD FOR LOW-CARBON CEMENT CLINKER

(71) Applicants: CHINA BUILDING MATERIALS ACADEMY CO., LTD., Beijing (CN); CBMI CONSTRUCTION CO., LTD., Tangshan (CN); CHINA NATIONAL BUILDING MATERIAL GROUP CO., LTD., Beijing (CN)

(72) Inventors: Xiao ZHI, Beijing (CN); Bin WANG, Beijing (CN); Wensheng ZHANG, Beijing (CN); Chao ZHANG, Beijing (CN); Jiayuan YE, Beijing (CN); Xuehong REN, Beijing (CN); Daliang CHI, Beijing (CN); Ying TAO, Beijing (CN); Chengwen XU, Beijing (CN); Chunying ZHOU, Beijing (CN)

(73) Assignees: CHINA BUILDING MATERIALS ACADEMY CO., LTD., Beijing (CN); CBMI CONSTRUCTION CO., LTD., Tangshan (CN); CHINA NATIONAL BUILDING MATERIAL GROUP CO., LTD., Beijing (CN)

(21) Appl. No.: 18/963,084

(22) Filed: Nov. 27, 2024

(30) Foreign Application Priority Data
Aug. 19, 2024 (CN) 202411139303.1

(51) Int. Cl. C04B 7/43; C04B 7/44

(52) U.S. Cl. CPC C04B 7/434; C04B 7/4476

(57) ABSTRACT

The disclosure relates to the technical field of cement manufacturing, and specifically relates to a calcination system and method for low-carbon cement clinker. The calcination system includes: a kaolin calcination assembly including a preheater and a decomposition furnace, where the preheater is provided with a multi-stage cyclone cylinder; the preheater is provided with a feed port and a discharge port; the decomposition furnace is provided with a fuel adding port and a raw material inlet; the raw material inlet is connected to the discharge port; activated kaolin is generated by the decomposition furnace through calcination; and the decomposition furnace has a calcination temperature of 700° C. to 850° C. and calcination time of 0 h to 1.5 h, and a calcination atmosphere in the decomposition furnace is an oxygen-enriched atmosphere or a CO reducing atmosphere; and a cement calcination assembly configured to generate cement clinker through calcination, where the activated kaolin is added to a discharge side of the cement calcination assembly according to a predetermined ratio of the activated kaolin to the cement clinker. Use of carbon-containing raw materials in clinker production and carbon emissions of clinker are reduced, and a hydration rate of the cement clinker is adjusted.

### TECHNICAL FIELD

The disclosure relates to the technical field of cement manufacturing, and specifically relates to a calcination system and method for low-carbon cement clinker.

### BACKGROUND

Main carbon dioxide emissions in a production process of cement materials are generated by decomposition of carbonate minerals in clinker calcination, which can account for 60% or more of carbon dioxide emissions in an entire production process. Therefore, major measures currently taken by the cement industry are developing alternative raw materials and technologies for energy saving and consumption reducing of production processes, and reducing clinker usage amount in cement and energy consumption.

### SUMMARY OF THE INVENTION

In view of that, the disclosure provides a calcination system and method for low-carbon cement clinker, so as to solve problems of a great usage amount of clinker in cement and high energy consumption.

In a first aspect, the disclosure provides a calcination system for low-carbon cement clinker. The calcination system includes:
a kaolin calcination assembly including a preheater and a decomposition furnace, where
the preheater is provided with a multi-stage cyclone cylinder; the preheater is provided with a feed port and a discharge port;
the decomposition furnace is provided with a fuel adding port and a raw material inlet; the raw material inlet is connected to the discharge port; activated kaolin is generated by the decomposition furnace through calcination; and
the decomposition furnace has a calcination temperature of 700° C. to 850° C. and calcination time of 0 h to 1.5 h, and a calcination atmosphere in the decomposition furnace is an oxygen-enriched atmosphere or a CO reducing atmosphere; and
a cement calcination assembly configured to generate cement clinker through calcination, where the activated kaolin is added to a discharge side of the cement calcination assembly according to a predetermined ratio of the activated kaolin to the cement clinker.

Beneficial effects are as follows: in examples of the disclosure, on the basis of an original cement raw material ratio, kaolin is added, such that use of carbon-containing raw materials in clinker production and carbon emissions of clinker can be reduced, and a hydration rate of the cement clinker can be adjusted. In addition, the kaolin may be calcined and activated, and meanwhile, the calcined kaolin may be added to the discharge side of the cement calcination assembly. For instance, through collaborative cooling of the discharge port at a head of a rotary kiln or a material inlet of a grate cooler, overall energy saving and carbon reduction of the calcination system can be achieved. Moreover, a layered aluminosilicate structure in the kaolin is dehydrated and decomposed at high temperature, and further conducts structural reorganization. Six-coordinated aluminum ions are transformed into four-coordinated activated alumina that has higher chemical reaction activity. Some silicon-oxygen bonds of the layered structure are broken, such that island-like active silicon oxide is formed, further enhancing material activity. Moreover, with increase in specific surface area and change in average hole diameter and hole size, a surface area of a material increases, and an internal structure of the material becomes more porous, such that contact areas with other substances and reaction efficiency can be improved. Therefore, active sites on a surface and a structure of the cement clinker can be increased, and performance of a final cement product can be significantly enhanced. For instance, cohesive force can be strengthened, durability can be improved, or other physical and chemical properties can be adjusted.

In one optional embodiment, the preheater is provided with a three-stage cyclone cylinder including a first cyclone cylinder, a second cyclone cylinder, and a third cyclone cylinder.

The first cyclone cylinder is provided with a first air inlet cylinder and two first cyclones arranged in parallel at a tail end of the first air inlet cylinder. The first air inlet cylinder is provided with a first air inlet and the feed port. A top of the first cyclone is provided with a first exhaust port. A bottom of the first cyclone is provided with a first discharging port.

The second cyclone cylinder is provided with a second air inlet cylinder and a second cyclone connected to a tail end of the second air inlet cylinder. The second air inlet cylinder is provided with a second air inlet and a pair of return ports. A top of the second cyclone is provided with a second exhaust port. A bottom of the second cyclone is provided with a second discharging port.

The pair of return ports are connected to the two first discharging ports respectively. The second exhaust port is connected to the first air inlet. The second discharging port constitutes the discharge port of the preheater.

The third cyclone cylinder is provided with a third air inlet cylinder and a third cyclone. One end of the third air inlet cylinder is in communication with a fume outlet of the decomposition furnace. The other end of the third air inlet cylinder is connected to the third cyclone. A top of the third cyclone is provided with a third exhaust port. A bottom of the third cyclone is provided with a third discharging port.

The third exhaust port is connected to the second air inlet. Waste is discharged out of the third discharging port.

In a first embodiment, the decomposition furnace has a calcination temperature of 750° C. and calcination time of 1 h, and a calcination atmosphere in the decomposition furnace is the oxygen-enriched atmosphere.

In the first embodiment, the activated kaolin is added to the cement calcination assembly according to a mass ratio 10% of the activated kaolin to a final product.

In a second embodiment, an area of the second exhaust port of the second cyclone is 1.4 m² to 1.6 m², and a height of an outer cylinder of the second cyclone is 1.9 m to 2.1 m. The decomposition furnace is provided with two fuel adding ports and a single raw material inlet. The fuel adding ports are located at one side of the raw material inlet.

In the second embodiment, the calcination temperature is 700° C. to 850° C., the calcination time is 1 h, and the calcination atmosphere in the decomposition furnace is a CO atmosphere.

In the second embodiment, the activated kaolin is added to the cement calcination assembly according to a mass ratio 15% of the activated kaolin to a final product.

In a third embodiment, a CO reducing tube is additionally arranged between the second air inlet and the third exhaust port of the third cyclone. The decomposition furnace is provided with three fuel adding ports and three raw material inlets. The fuel adding ports are arranged facing away from all the raw material inlets. The fuel adding ports are located upstream of the raw material inlets in an airflow direction.

In the third embodiment, the calcination temperature is 750° C., the calcination time is 1.5 h, and the calcination atmosphere is a CO atmosphere.

In the third embodiment, the activated kaolin is added to the cement calcination assembly according to a mass ratio 20% of the activated kaolin to a final product.

In a fourth embodiment, an air inlet of the decomposition furnace is connected to an extending tube. One end of the extending tube away from the air inlet is connected to an inlet tube. A tail end of the inlet tube is trumpet-shaped.

The inlet tube is symmetrically provided with two raw material inlets. One end of the extending tube close to the inlet tube is provided with two fuel adding ports. A third raw material inlet and a third fuel adding port are located on the extending tube. An included angle between a feeding direction of both the third raw material inlet and the third fuel adding port and an extending direction of a feeding tube is a right angle. The feeding tube is arranged between the preheater and the decomposition furnace.

In the fourth embodiment, the calcination temperature is 750° C., the calcination time is 0.5 h to 1.5 h, and the calcination atmosphere is a CO 165 ppm atmosphere.

In the fourth embodiment, the activated kaolin is added to the cement calcination assembly according to a mass ratio 5% of the activated kaolin to a final product.

In a second aspect, the disclosure further provides a calcination method for low-carbon cement clinker. The calcination method includes:
drying and grinding a cement crude material and kaolin separately, and obtaining a cement raw material and a kaolin raw material;
adding the cement raw material into a cement calcination assembly for high-temperature calcination, and generating cement clinker;
introducing the kaolin raw material into a kaolin calcination assembly for calcination and activation, and generating activated kaolin;
adding the activated kaolin to a discharge side of the cement calcination assembly according to a predetermined ratio of the activated kaolin to the cement clinker; and
cooling a mixture of the cement clinker and the activated kaolin by a grate cooler, and obtaining the cement clinker containing the kaolin.

In one optional embodiment, the grinding kaolin includes:
controlling, during grinding of the kaolin, fineness of kaolin powder after grinding to be 75 μm to 85 μm and screen residues to be 4% to 6%.

In one optional embodiment, the adding the activated kaolin to a discharge side of the cement calcination assembly includes:
adding the activated kaolin into a discharge port of the cement calcination assembly or a material inlet of the grate cooler.

### BRIEF DESCRIPTION OF THE DRAWINGS

In order to more clearly illustrate technical solutions in specific embodiments of the disclosure or in the related art, the accompanying drawings required for description of the specific embodiments or the related art will be briefly introduced below. Obviously, the accompanying drawings in the following description are some embodiments of the disclosure, and those of ordinary skill in the art can still derive other drawings from these accompanying drawings without any creative effort.

FIG. 1 is a schematic structural diagram of a preheater and a decomposition furnace in an example of the disclosure;

FIG. 2 is a schematic structural diagram of a first cyclone cylinder in an example of the disclosure;

FIG. 3 is a schematic structural diagram of a second cyclone cylinder in an example of the disclosure;

FIG. 4 is a schematic structural diagram of a third cyclone cylinder in an example of the disclosure; and

FIG. 5 is a schematic structural diagram of a decomposition furnace in Example 4.

### DESCRIPTION OF REFERENCE NUMERALS

1, preheater;
11, first cyclone cylinder; 111, first air inlet cylinder; 1111, first air inlet; 1112, feed port; 112, first cyclone; 1121, first exhaust port; 1122, first discharging port;
12, second cyclone cylinder; 121, second air inlet cylinder; 1211, second air inlet; 1212, return port; 122, second cyclone; 1221, second exhaust port; 1222, second discharging port;
13, third cyclone cylinder; 131, third air inlet cylinder; 132, third cyclone; 1321, third exhaust port; 1322, third discharging port;
2, decomposition furnace; 21, extending tube; 22, inlet tube; 23, raw material inlet; 24, fuel adding port.

### DETAILED DESCRIPTION

To make objectives, technical solutions and advantages of examples of the disclosure clearer, the technical solutions in the examples of the disclosure will be clearly and completely described below in conjunction with the accompanying drawings in the examples of the disclosure. Obviously, the described examples are some examples rather than all the examples of the disclosure. On the basis of the examples of the disclosure, all the other examples obtained by those skilled in the art without any creative effort fall within the protection scope of the disclosure.

In the description of the disclosure, it should be noted that the terms “central”, “upper”, “lower”, “left”, “right”, “vertical”, “horizontal”, “inner”, “outer”, etc. indicate azimuthal or positional relations based on those shown in the drawings only for ease of description of the disclosure and for simplicity of description, and are not intended to indicate or imply that the referenced apparatus or element must have a particular orientation and be constructed and operative in a particular orientation, and thus cannot be construed as a limitation on the disclosure. In addition, the terms “first”, “second”, and “third” are only for descriptive purposes, and cannot be interpreted as indicating or implying relative importance.

In the description of the disclosure, it should be noted that, unless expressly specified and defined otherwise, the terms “mount”, “connect”, and “connected” are to be construed broadly. For instance, they can denote fixed connection, detachable connection or integral connection, denote mechanical connection or electric connection, denote direct connection or indirect connection by means of an intermediate medium, denote communication between interiors of two elements, or denote wireless connection or wired connection. For those of ordinary skill in the art, specific meanings of the above terms in the disclosure can be understood according to specific circumstances.

Further, technical features involved in different embodiments of the disclosure described below can be combined with one another as long as they do not constitute a conflict with one another.

Main carbon dioxide emissions in a production process of cement materials are generated by decomposition of carbonate minerals in clinker calcination, which can account for 60% or more of carbon dioxide emissions in an entire production process. Therefore, major measures currently taken by the cement industry are developing alternative raw materials and technologies for energy saving and consumption reducing of production processes, and reducing clinker usage amount in cement and energy consumption.

In view of that, the disclosure provides a calcination system and method for low-carbon cement clinker, so as to solve problems of a great usage amount of clinker in cement and high energy consumption.

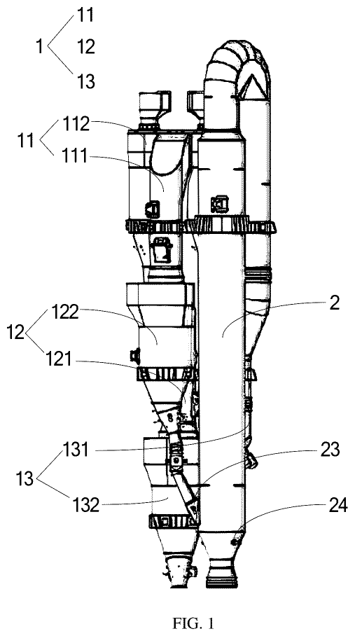

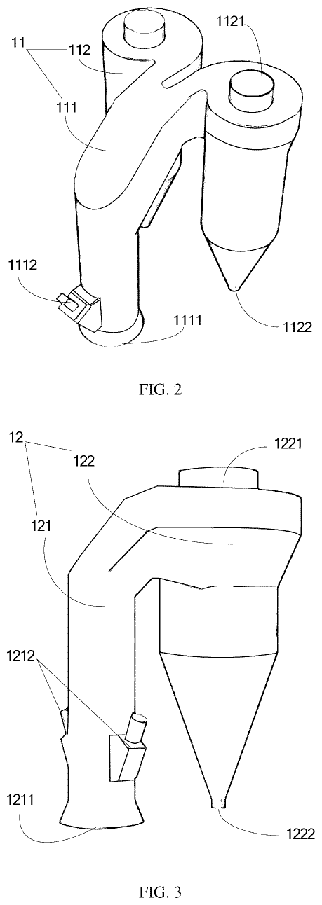

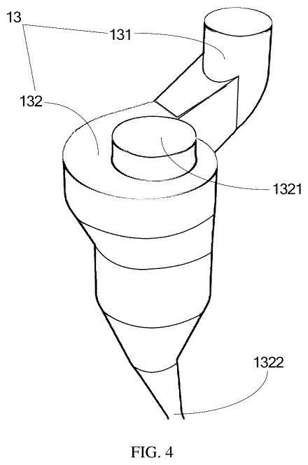

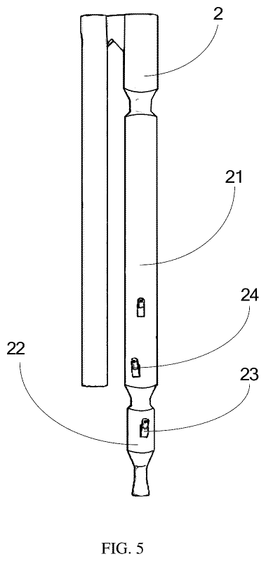

With reference to FIGS. 1-5, the examples of the disclosure will be described below.

In one aspect, the examples of the disclosure provide a calcination system for low-carbon cement clinker. The calcination system includes a kaolin calcination assembly and a cement calcination assembly.

Specifically, in an example of the disclosure, the kaolin calcination assembly includes a preheater 1 and a decomposition furnace 2.

Further, the preheater 1 is provided with a multi-stage cyclone cylinder. The preheater 1 is provided with a feed port 1112, a discharge port, and a waste port. Raw material powder is added from the feed port 1112, and a newly added cold raw material may make contact with hot flue gas from the decomposition furnace 2. Through direct heat exchange, the raw material is gradually heated, and meanwhile, the flue gas is gradually cooled, such that heat is gradually recovered. In a system of multi-stage cyclones, the raw material may pass the plurality of cyclones sequentially, and a temperature of the raw material may increase once after the raw material passes one stage of cyclone. Meanwhile, a temperature of the flue gas may gradually decrease until the material enters the decomposition furnace 2 via the discharge port. Through the waste port, large heavy particles in the raw material may be returned to a grinding system for grinding. The raw material powder after re-grinding may be added into the preheater 1 again through the feed port 1112.

Further, the decomposition furnace 2 is provided with a fuel adding port 24 and a raw material inlet 23. The raw material inlet 23 is connected to the discharge port. Activated kaolin is generated by the decomposition furnace 2 through calcination. The decomposition furnace 2 has a calcination temperature of 700° C. to 850° C. and calcination time of 0 h to 1.5 h. A calcination atmosphere in the decomposition furnace 2 is an oxygen-enriched atmosphere or a CO reducing atmosphere.

Further, the cement calcination assembly may be a rotary kiln. The cement calcination assembly is configured to generate cement clinker through calcination. The activated kaolin is added to a discharge side of the cement calcination assembly according to a predetermined ratio of the activated kaolin to the cement clinker. The predetermined ratio may be 5%, 10%, 15%, 20%, etc., for instance.

In the examples of the disclosure, on the basis of an original cement raw material ratio, kaolin is added, such that use of carbon-containing raw materials in clinker production and carbon emissions of clinker can be reduced, and a hydration rate of the cement clinker can be adjusted. In addition, the kaolin may be calcined and activated, and meanwhile, the calcined kaolin may be added to the discharge side of the cement calcination assembly. For instance, through collaborative cooling of the discharge port at a head of a rotary kiln or a material inlet of a grate cooler, overall energy saving and carbon reduction of the calcination system can be achieved. Moreover, a layered aluminosilicate structure in the kaolin is dehydrated and decomposed at high temperature, and further conducts structural reorganization. Six-coordinated aluminum ions are transformed into four-coordinated activated alumina that has higher chemical reaction activity. Some silicon-oxygen bonds of the layered structure are broken, such that island-like active silicon oxide is formed, further enhancing material activity. Moreover, with increase in specific surface area and change in average hole diameter and hole size, a surface area of a material increases, and an internal structure of the material becomes more porous, such that contact areas with other substances and reaction efficiency can be improved. Therefore, active sites on a surface and a structure of the cement clinker can be increased, and performance of a final cement product can be significantly enhanced. For instance, cohesive force can be strengthened, durability can be improved, or other physical and chemical properties can be adjusted.

Further, in one optional embodiment, the preheater 1 is provided with a three-stage cyclone cylinder including a first cyclone cylinder 11, a second cyclone cylinder 12, and a third cyclone cylinder 13.

In an example of the disclosure, the first cyclone cylinder 11 is provided with a first air inlet cylinder 111 and two first cyclones 112 arranged in parallel at a tail end of the first air inlet cylinder 111. The first air inlet cylinder 111 is provided with a first air inlet 1111 and the feed port 1112. A top of the first cyclone 112 is provided with a first exhaust port 1121. A bottom of the first cyclone 112 is provided with a first discharging port 1122.

Further, the second cyclone cylinder 12 is provided with a second air inlet cylinder 121 and a second cyclone 122 connected to a tail end of the second air inlet cylinder 121. The second air inlet cylinder 121 is provided with a second air inlet 1211 and a pair of return ports 1212. A top of the second cyclone 122 is provided with a second exhaust port 1221. A bottom of the second cyclone 122 is provided with a second discharging port 1222.

Regarding a connection mode of the second cyclone cylinder 12, the pair of return ports 1212 are connected to the two first discharging ports 1122 respectively; and the second exhaust port 1221 is connected to the first air inlet 1111, and the second discharging port 1222 constitutes the discharge port of the preheater 1.

Further, the third cyclone cylinder 13 is provided with a third air inlet cylinder 131 and a third cyclone 132. One end of the third air inlet cylinder 131 is in communication with a fume outlet of the decomposition furnace 2, and the other end of the third air inlet cylinder 131 is connected to the third cyclone 132. A top of the third cyclone 132 is provided with a third exhaust port 1321. A bottom of the third cyclone 132 is provided with a third discharging port 1322. The third discharging port 1322 constitutes the waste port of the preheater 1.

Regarding a connection mode of the third cyclone cylinder 13, the third exhaust port 1321 is connected to the second air inlet 1211, and waste is discharged out of the third discharging port 1322.

In order to illustrate the disclosure and better understand the technical solutions and advantages, the disclosure will be described in detail with the examples and the drawings, and the disclosure is not limited to the following examples.

### Example 1

In a first embodiment, the decomposition furnace 2 has a calcination temperature of 750° C. and calcination time of 1 h, and a calcination atmosphere in the decomposition furnace 2 is the oxygen-enriched atmosphere. Chemical composition of kaolin is shown in Table 1.

TABLE 1
Chemical composition of kaolin

| Raw material | CaO | SiO₂ | Al₂O₃ | Fe₂O₃ | MgO | SO₃ | K₂O | Na₂O | Loss |
|---|---|---|---|---|---|---|---|---|---|
| Kaolin | 1.83 | 64.25 | 14.58 | 4.20 | 1.83 | 2.20 | 2.76 | 0.21 | 8.14 |

In the first embodiment, the activated kaolin is added to the cement calcination assembly according to a mass ratio 10% of the activated kaolin to a final product.

An adding position is at a material inlet of a grate cooler. According to GB/T 17671-2021 “Cement Mortar Strength Test Method (ISO Method)”, flexural and compressive strengths of produced cement clinker containing kaolin of 3 days, 7 days and 28 days are measured, and results are shown in Table 2.

TABLE 2
Measurement results of strengths of kaolin-containing
cement clinker calcined in an eutrophic atmosphere

| | | |
|---|---|---|
| Curing time | Strength | O₂ concentration (%) |

| (day) | (MPa) | 5 | 10 | 20 | 30 |
|---|---|---|---|---|---|
| 3 | Flexural | 8.7 | 9.0 | 9.5 | 9.8 |
| | Compressive | 29.1 | 32.2 | 34.3 | 34.5 |
| 7 | Flexural | 9.8 | 10.4 | 10.2 | 10.9 |
| | Compressive | 35.0 | 38.2 | 39.5 | 40.0 |
| 28 | Flexural | 11.9 | 12.2 | 12.5 | 12.5 |
| | Compressive | 45.3 | 47.6 | 48.7 | 49.3 |

### Example 2

In a second embodiment, an area of the second exhaust port 1221 of the second cyclone 122 is 1.4 m² to 1.6 m², and a height of an outer cylinder of the second cyclone 122 is 1.9 m to 2.1 m. The decomposition furnace 2 is provided with two fuel adding ports 24 and a single raw material inlet 23. The fuel adding ports 24 are located at one side of the raw material inlet 23. In the second embodiment, a calcination temperature is 700° C. to 850° C., calcination time is 1 h, and a calcination atmosphere in the decomposition furnace 2 is a CO atmosphere. Chemical composition of kaolin is shown in Table 3.

TABLE 3
Chemical composition of kaolin

| Raw material | CaO | SiO₂ | Al₂O₃ | Fe₂O₃ | MgO | SO₃ | K₂O | Na₂O | Loss |
|---|---|---|---|---|---|---|---|---|---|
| Kaolin | 1.65 | 62.15 | 15.36 | 4.36 | 2.05 | 1.68 | 2.14 | 0.36 | 10.25 |

In the second embodiment, the activated kaolin is added to the cement calcination assembly according to a mass ratio 15% of the activated kaolin to a final product. An adding position is at a discharge port of a kiln head. According to GB/T 17671-2021 “Cement Mortar Strength Test Method (ISO Method)”, flexural and compressive strengths of produced cement clinker containing kaolin of 3 days, 7 days and 28 days are measured, and results are shown in Table 4.

TABLE 4
Measurement results of strengths of kaolin-containing
cement clinker calcined at different temperatures

| Curing time | Strength | Calcination temperature (° C.) | | | |
|---|---|---|---|---|---|
| (day) | (MPa) | 700 | 750 | 800 | 850 |
| 3 | Flexural | 10.1 | 9.8 | 10.0 | 10.2 |
| | Compressive | 32.7 | 32.3 | 34.5 | 34.1 |
| 7 | Flexural | 10.9 | 11.7 | 10.8 | 11.2 |
| | Compressive | 39.1 | 39.8 | 41.7 | 37.3 |
| 28 | Flexural | 12.9 | 12.9 | 13.3 | 13.4 |
| | Compressive | 46.3 | 49.6 | 50.4 | 49.4 |

### Example 3

In a third embodiment, compared with the first two examples, a size of each stage of cyclone cylinder is increased. A CO reducing tube is additionally arranged between the second air inlet 1211 and the third exhaust port 1321 of the third cyclone 132. The decomposition furnace 2 is provided with three fuel adding ports 24 and three raw material inlets 23. The fuel adding ports 24 are arranged facing away from all the raw material inlets 23. The fuel adding ports 24 are located upstream of the raw material inlets 23 in an airflow direction.

In the third embodiment, a calcination temperature is 750° C., calcination time is 1.5 h, and a calcination atmosphere is a CO atmosphere. Chemical composition of kaolin is shown in Table 5.

TABLE 5
Chemical composition of kaolin

| Raw material | CaO | SiO₂ | Al₂O₃ | Fe₂O₃ | MgO | SO₃ | K₂O | Na₂O | Loss |
|---|---|---|---|---|---|---|---|---|---|
| Kaolin | 2.24 | 65.17 | 13.28 | 4.15 | 1.95 | 2.36 | 2.55 | 0.18 | 8.12 |

In the third embodiment, the activated kaolin is added to the cement calcination assembly according to a mass ratio 20% of the activated kaolin to a final product. An adding position is at a discharge port of a kiln head. According to GB/T 17671-2021 “Cement Mortar Strength Test Method (ISO Method)”, flexural and compressive strengths of produced cement clinker containing kaolin of 3 days, 7 days and 28 days are measured, and results are shown in Table 6.

TABLE 6
Measurement results of strengths of kaolin-containing
cement clinker calcined in a reducing atmosphere

| | | |
|---|---|---|
| Curing time | Strength | CO concentration (ppm) |

| (day) | (MPa) | 100 | 165 | 200 | 400 |
|---|---|---|---|---|---|
| 3 | Flexural | 8.9 | 9.1 | 8.5 | 8.4 |
| | Compressive | 29.2 | 28.9 | 26.8 | 26.2 |
| 7 | Flexural | 9.6 | 9.7 | 9.4 | 9.3 |
| 28 | Compressive | 34.5 | 33.7 | 31.5 | 30.1 |
| | Flexural | 11.5 | 12.5 | 11.3 | 10.9 |
| | Compressive | 46.7 | 48.2 | 44.2 | 41.2 |

### Example 4

In a fourth embodiment, an air inlet of the decomposition furnace 2 is connected to an extending tube 21. One end of the extending tube 21 away from the air inlet is connected to an inlet tube 22. A tail end of the inlet tube 22 is trumpet-shaped. The inlet tube 22 is symmetrically provided with two raw material inlets 23. One end of the extending tube 21 close to the inlet tube 22 is provided with two fuel adding ports 24. A third raw material inlet 23 and a third fuel adding port 24 are located on the extending tube 21. An included angle between a feeding direction of both the third raw material inlet 23 and the third fuel adding port 24 and an extending direction of a feeding tube is a right angle. The feeding tube is arranged between the preheater 1 and the decomposition furnace 2.

In the fourth embodiment, a calcination temperature is 750° C., calcination time is 0.5 h to 1.5 h, and a calcination atmosphere is a CO 165 ppm atmosphere. Chemical composition of kaolin is shown in Table 7.

TABLE 7
Chemical composition of kaolin

| Raw material | CaO | SiO₂ | Al₂O₃ | Fe₂O₃ | MgO | SO₃ | K₂O | Na₂O | Loss |
|---|---|---|---|---|---|---|---|---|---|
| Kaolin | 3.25 | 61.57 | 16.28 | 3.98 | 1.66 | 1.79 | 2.48 | 0.28 | 8.71 |

In the fourth embodiment, the activated kaolin is added to the cement calcination assembly according to a mass ratio 5% of the activated kaolin to a final product. An adding position is at a material inlet of a grate cooler. According to GB/T 17671-2021 “Cement Mortar Strength Test Method (ISO Method)”, flexural and compressive strengths of produced cement clinker containing kaolin of 3 days, 7 days and 28 days are measured, and results are shown in Table 8.

TABLE 8
Measurement results of strengths of kaolin-containing
cement clinker calcined for different time

| | |
|---|---|
| Strength | Time (h) |

| Curing time (day) | (MPa) | 0.5 | 1 | 1.5 |
|---|---|---|---|---|
| 3 | Flexural | 8.8 | 9.2 | 9.5 |
| | Compressive | 31.5 | 33.7 | 34.3 |
| 7 | Flexural | 9.5 | 10.5 | 10.9 |
| | Compressive | 36.7 | 39.2 | 40.5 |
| 28 | Flexural | 10.8 | 12.1 | 12.5 |
| | Compressive | 46.5 | 48.2 | 50.3 |

In a second aspect, the disclosure further provides a calcination method for low-carbon cement clinker. The calcination method included the following steps:
S1, a cement crude material and kaolin were dried and ground separately, and a cement raw material and a kaolin raw material were obtained;
S2, the cement raw material was added into a cement calcination assembly for high-temperature calcination, and cement clinker was generated;
S3, the kaolin raw material was introduced into a kaolin calcination assembly for calcination and activation, and activated kaolin was generated;
S4, the activated kaolin was added to a discharge side of the cement calcination assembly according to a predetermined ratio of the activated kaolin to the cement clinker; and
S5, a mixture of the cement clinker and the activated kaolin was cooled by a grate cooler, and the cement clinker containing the kaolin was obtained.

Further, in one optional embodiment, the step that the kaolin was ground included the following step:
during grinding of the kaolin, fineness of kaolin powder after grinding was controlled to be 75 μm to 85 μm, and screen residues were controlled to be 4% to 6%.

Further, in one optional embodiment, the step that the activated kaolin was added to the discharge side of the cement calcination assembly included the following step:
the activated kaolin was added into a discharge port of the cement calcination assembly or a material inlet of the grate cooler.

Although the examples of the disclosure are described in connection with the drawings, those skilled in the art can make various modifications and variations without departing from the spirit and scope of the disclosure, and such modifications and variations shall all fall within the scope defined by the appended claims.

1. A calcination system for low-carbon cement clinker, comprising:
a kaolin calcination assembly comprising a preheater (1) and a decomposition furnace (2), wherein
the preheater (1) is provided with a multi-stage cyclone cylinder; the preheater (1) is provided with a feed port (1112) and a discharge port;
the decomposition furnace (2) is provided with a fuel adding port (24) and a raw material inlet (23); the raw material inlet (23) is connected to the discharge port; activated kaolin is generated by the decomposition furnace (2) through calcination; and
the decomposition furnace (2) has a calcination temperature of 700° C. to 850° C. and calcination time of 0 h to 1.5 h, and a calcination atmosphere in the decomposition furnace (2) is an oxygen-enriched atmosphere or a CO reducing atmosphere; and
a cement calcination assembly configured to generate cement clinker through calcination, wherein the activated kaolin is added to a discharge side of the cement calcination assembly according to a predetermined ratio of the activated kaolin to the cement clinker.

2. The calcination system of claim 1, wherein the preheater (1) is provided with a three-stage cyclone cylinder comprising a first cyclone cylinder (11), a second cyclone cylinder (12) and a third cyclone cylinder (13);
the first cyclone cylinder (11) is provided with a first air inlet cylinder (111) and two first cyclones (112) arranged in parallel at a tail end of the first air inlet cylinder (111), and the first air inlet cylinder (111) is provided with a first air inlet (1111) and the feed port (1112); and a top of the first cyclone (112) is provided with a first exhaust port (1121), and a bottom of the first cyclone (112) is provided with a first discharging port (1122);
the second cyclone cylinder (12) is provided with a second air inlet cylinder (121) and a second cyclone (122) connected to a tail end of the second air inlet cylinder (121); and the second air inlet cylinder (121) is provided with a second air inlet (1211) and a pair of return ports (1212), a top of the second cyclone (122) is provided with a second exhaust port (1221), and a bottom of the second cyclone (122) is provided with a second discharging port (1222);
the pair of return ports (1212) are connected to the two first discharging ports (1122) respectively; and the second exhaust port (1221) is connected to the first air inlet (1111), and the second discharging port (1222) constitutes the discharge port of the preheater (1);
the third cyclone cylinder (13) is provided with a third air inlet cylinder (131) and a third cyclone (132); one end of the third air inlet cylinder (131) is in communication with a fume outlet of the decomposition furnace (2), and the other end of the third air inlet cylinder (131) is connected to the third cyclone (132); and a top of the third cyclone (132) is provided with a third exhaust port (1321), and a bottom of the third cyclone (132) is provided with a third discharging port (1322); and
the third exhaust port (1321) is connected to the second air inlet (1211), and waste is discharged out of the third discharging port (1322).

3. The calcination system of claim 2, wherein the decomposition furnace (2) has a calcination temperature of 750° C. and calcination time of 1 h, and a calcination atmosphere in the decomposition furnace (2) is the oxygen-enriched atmosphere.

4. The calcination system of claim 3, wherein the activated kaolin is added to the cement calcination assembly according to a mass ratio 10% of the activated kaolin to a final product.

5. The calcination system of claim 2, wherein an area of the second exhaust port (1221) of the second cyclone (122) is 1.4 m² to 1.6 m², and a height of an outer cylinder of the second cyclone (122) is 1.9 m to 2.1 m; and the decomposition furnace (2) is provided with two fuel adding ports (24) and a single raw material inlet (23), and the fuel adding ports (24) are located at one side of the raw material inlet (23).

6. The calcination system of claim 5, wherein the calcination temperature is 700° C. to 850° C., the calcination time is 1 h, and the calcination atmosphere in the decomposition furnace (2) is a CO atmosphere.

7. The calcination system of claim 6, wherein the activated kaolin is added to the cement calcination assembly according to a mass ratio 15% of the activated kaolin to a final product.

8. The calcination system of claim 2, wherein a CO reducing tube is additionally arranged between the second air inlet (1211) and the third exhaust port (1321) of the third cyclone (132); and the decomposition furnace (2) is provided with three fuel adding ports (24) and three raw material inlets (23), the fuel adding ports (24) are arranged facing away from all the raw material inlets (23), and the fuel adding ports (24) are located upstream of the raw material inlets (23) in an airflow direction.

9. The calcination system of claim 8, wherein the calcination temperature is 750° C., the calcination time is 1.5 h, and the calcination atmosphere is a CO atmosphere.

10. The calcination system of claim 9, wherein the activated kaolin is added to the cement calcination assembly according to a mass ratio 20% of the activated kaolin to a final product.

11. The calcination system of claim 2, wherein an air inlet of the decomposition furnace (2) is connected to an extending tube (21), one end of the extending tube (21) away from the air inlet is connected to an inlet tube (22), and a tail end of the inlet tube (22) is trumpet-shaped;
the inlet tube (22) is symmetrically provided with two raw material inlets (23), one end of the extending tube (21) close to the inlet tube (22) is provided with two fuel adding ports (24), a third raw material inlet (23) and a third fuel adding port (24) are located on the extending tube (21), and an included angle between a feeding direction of both the third raw material inlet (23) and the third fuel adding port (24) and an extending direction of a feeding tube is a right angle; and the feeding tube is arranged between the preheater (1) and the decomposition furnace (2).

12. The calcination system of claim 11, wherein the calcination temperature is 750° C., the calcination time is 0.5 h to 1.5 h, and the calcination atmosphere is a CO 165 ppm atmosphere.

13. The calcination system of claim 12, wherein the activated kaolin is added to the cement calcination assembly according to a mass ratio 5% of the activated kaolin to a final product.

14. A calcination method for low-carbon cement clinker, comprising:
drying and grinding a cement crude material and kaolin separately, and obtaining a cement raw material and a kaolin raw material;
adding the cement raw material into a cement calcination assembly for calcination, and generating cement clinker;
introducing the kaolin raw material into a kaolin calcination assembly for calcination and activation, and generating activated kaolin;
adding the activated kaolin to a discharge side of the cement calcination assembly according to a predetermined ratio of the activated kaolin to the cement clinker; and
cooling a mixture of the cement clinker and the activated kaolin by a grate cooler, and obtaining the cement clinker containing the kaolin.

15. The calcination method of claim 14, wherein the grinding kaolin comprises:
controlling, during grinding of the kaolin, fineness of kaolin powder after grinding to be 75 μm to 85 μm and screen residues to be 4% to 6%.

16. The calcination method of claim 14, wherein the adding the activated kaolin to a discharge side of the cement calcination assembly comprises:
adding the activated kaolin into a discharge port of the cement calcination assembly or a material inlet of the grate cooler.

17. The calcination method of claim 15, wherein the adding the activated kaolin to a discharge side of the cement calcination assembly comprises:
adding the activated kaolin into a discharge port of the cement calcination assembly or a material inlet of the grate cooler.
